(19) United States
(12) Patent Application Publication
(10) Pub. No.: US 2010/0088622 A1
(43) Pub. Date: Apr. 8, 2010

(54) Method of Relocating and Displaying Notification Icon on a Computer System and Related Device

(76) Inventors: Kuo-Hsiang Sun, Taipei City (TW); Wen-Shiu Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/564,036

(22) Filed: Sep. 21, 2009

(30) Foreign Application Priority Data
Oct. 7, 2008 (TW) 097138567

(51) Int. Cl. G06F 3/048

(52) U.S. Cl. 715/765

(57) ABSTRACT

A method of relocating a notification icon corresponding to a notification area displayed on a computer screen includes providing a display window displayed on the screen, hooking messages inputted to or outputted from the notification area, obtaining icon information and function information of the notification icon according to the hooked messages, hiding the notification icon, displaying the notification icon on the display window according to the icon information, and then providing functions of the notification icon according to the function information.

### BACKGROUND OF THE INVENTION

1. Field of the Invention

The present invention relates to a method of managing a notification icon related to a notification area on a computer system and related device, and more particularly, to a method of relocating and displaying a notification icon related to a notification area on a computer system and related device.

2. Description of the Prior Art

In a computer operating system, a notification area is used for displaying notification icons, a date and time. Each of the notification icons corresponds to an application program and is displayed on a screen by a small icon, so as to facilitate a user to use the application program through selecting the notification icon.

Please refer to FIG. 1, which is a schematic diagram of a notification area 10 of a window operating system displayed on a screen according to the prior art. The notification area 10 is next to a taskbar 12. A notification icon 14 is displayed in the notification area 10, and a function menu 16 of the notification icon 14 lists functions related to a main program, which include multi-window closing, desk extending, window ID displaying, and leaving.

For simplicity, FIG. 1 just shows a notification icon. However, in reality the user may install kinds of application programs to the window operating system so that the number of the notification icons increases drastically, and thereby influences utilizing space of the taskbar.

### SUMMARY OF THE INVENTION

Therefore, the present invention provides a method of relocating and displaying a notification icon related to a notification area on a computer system and related computer system for decreasing occupation of the notification area and enhancing convenience of notification icon usage.

The present invention discloses a method of relocating and displaying notification icon on a computer system. The computer system displays the notification area on a screen. The method includes hooking messages inputted to or outputted from the notification area, obtaining icon information and function information of the notification icon according to the hooked messages, hiding the notification icon, displaying the notification icon on a display window according to the icon information, and then providing functions of the notification icon according to the function information.

The present invention further discloses a computer system for relocating and displaying notification icon. The computer system includes a display window, a hooking unit, an information storage unit, a first icon relocating unit, and a second icon relocating unit. The computer system displays the notification area on a screen. The hooking unit is used for hooking messages inputted to or outputted from the notification area. The information storage unit is coupled to the hooking unit and used for obtaining icon information and function information of the notification icon according to the hooked messages. The first icon relocating unit is used for hiding the notification icon. The second icon relocating unit is used for displaying the notification icon on the display window according to the icon information, and providing functions of the notification icon according to the function information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a notification area according to the prior art.

FIG. 2 is a flow diagram of a process according to an embodiment of the present invention.

FIG. 3 is a schematic diagram of a display window according to an embodiment of the present invention.

FIG. 4 is a functional block diagram of a computer system according to an embodiment of the present invention.

### DETAILED DESCRIPTION

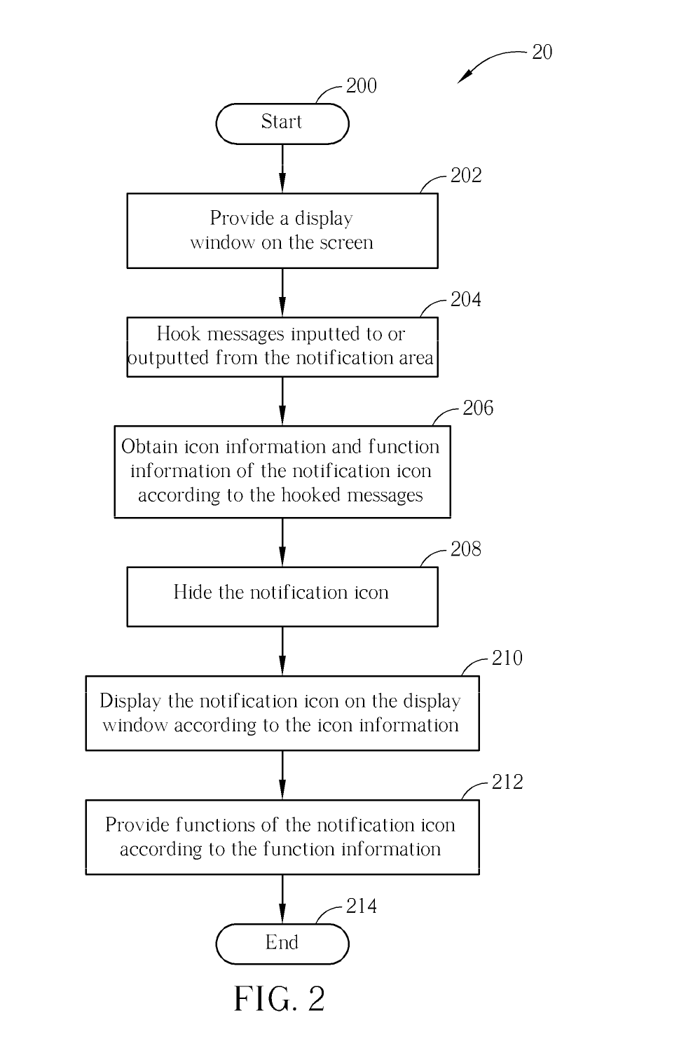

Please refer to FIG. 2, which is a flow diagram of a process 20 according to an embodiment of the present invention. The process 20 is used for relocating and displaying a notification icon related to a notification area on a computer system. The computer system displays the notification area on a screen, and is capable of displaying a plurality of the notification icons in the notification area. The process 20 includes the following steps:

Step 200: Start.

Step 202: Provide a display window on the screen.

Step 204: Hook messages inputted to or outputted from the notification area.

Step 206: Obtain icon information and function information of the notification icon according to the hooked messages.

Step 208: Hide the notification icon.

Step 210: Display the notification icon on the display window according to the icon information.

Step 212: Provide functions of the notification icon according to the function information.

Step 214: End.

According to the process 20, the embodiment of the present invention obtains all the icon information and function information related to the notification icon by hooking a message outputted and inputted to the notification area, and then hides the notification icon to stop displaying the notification icon in the notification area. Next, according to the icon and function information, the notification icon and related information (such as a path corresponding to a main program of the notification icon) are displayed on the display window and furthermore the functions corresponding to the notification icon are provided.

Preferably, the notification icon is a static icon or a dynamic icon. Step 204 can utilize a dynamic link library (DLL) file to hook messages transmitted between the notification area and an operating system of the computer system to obtain the icon information and the function information. In addition, in Step 212, the embodiment of the present invention displays a function menu corresponding to the notification icon through a mouse behavior, or pops up a main window of an application program corresponding to the notification icon. For example, the function menu can be displayed on the notification icon by moving a mouse cursor onto the notification icon and then right clicking the mouse once. Moreover, when the mouse cursor locates on the notification icon, the main window related to the application program can be popped up by double left mouse click.

In Step 208, when the process 20 is executed, the way of hiding the existing notification icon in the notification area is different from the way of hiding the new adding notification icon. The existing notification icons are deleted from the notification area when the process 20 obtains current icon information and the function information of all the notification icons in the notification area, and then displayed on the display window. In this situation, the existing notification icons are relocated from the notification area to the display window through the process 20, and the original functions thereof are simulated and kept. On the contrary, after the process 20 hooks the messages (such as a “add” command message) transmitted from the notification icon to the notification area, the new adding notification icon is marked as hiding state, and directly displayed in the display window to avoid appearance in the notification area. Preferably, the hiding and display operations of Step 208 can be implemented through an application programming interface (API).

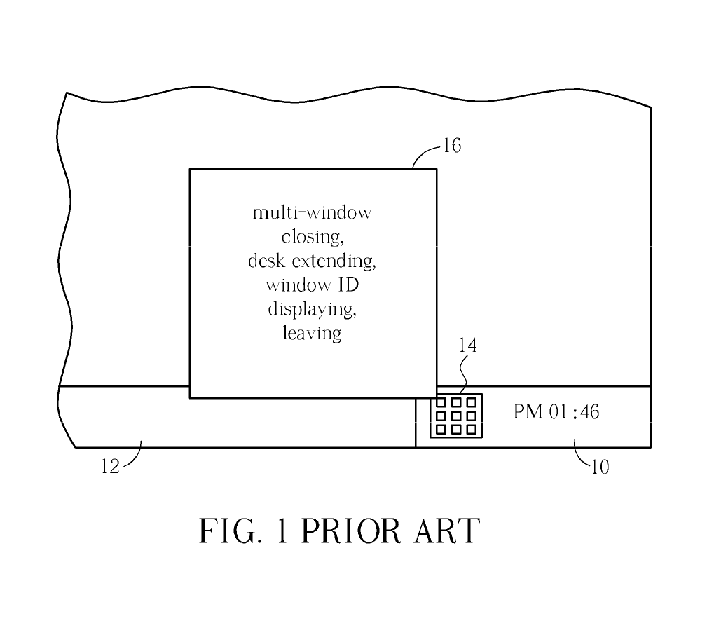

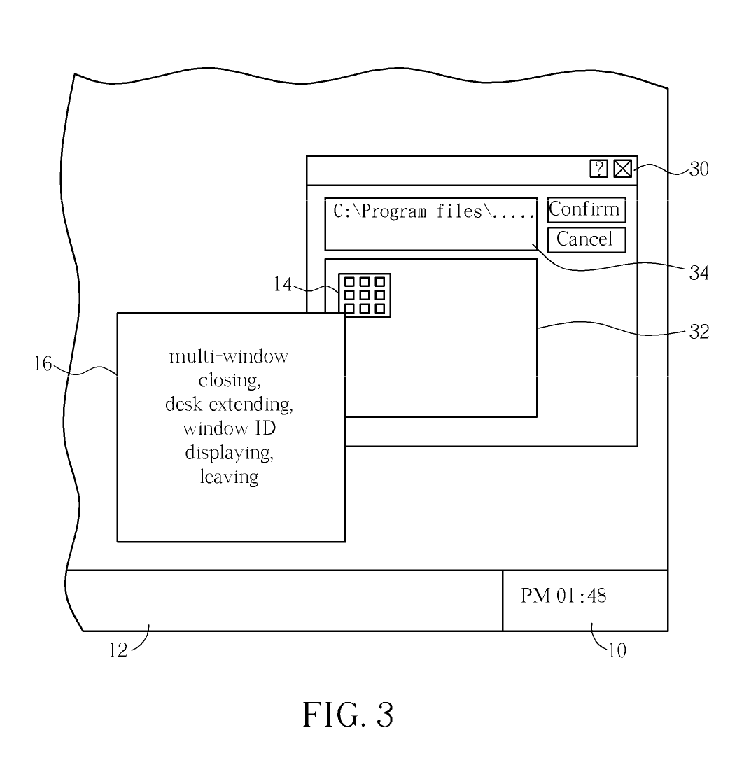

Please refer to FIG. 3, which is a schematic diagram of a display window 30 displayed on a screen according to an embodiment of the present invention. FIG. 3 provides the display window 30 in the window operating system in FIG. 1. The display window 30 includes an icon area 32 and a path area 34 for displaying a notification icon 14 and a path of a main program corresponding to the notification icon 14 respectively. As can be seen from FIG. 3, the notification icon 14 and the function menu 16 are relocated from the notification area 10 to the display window 30 without any modifications.

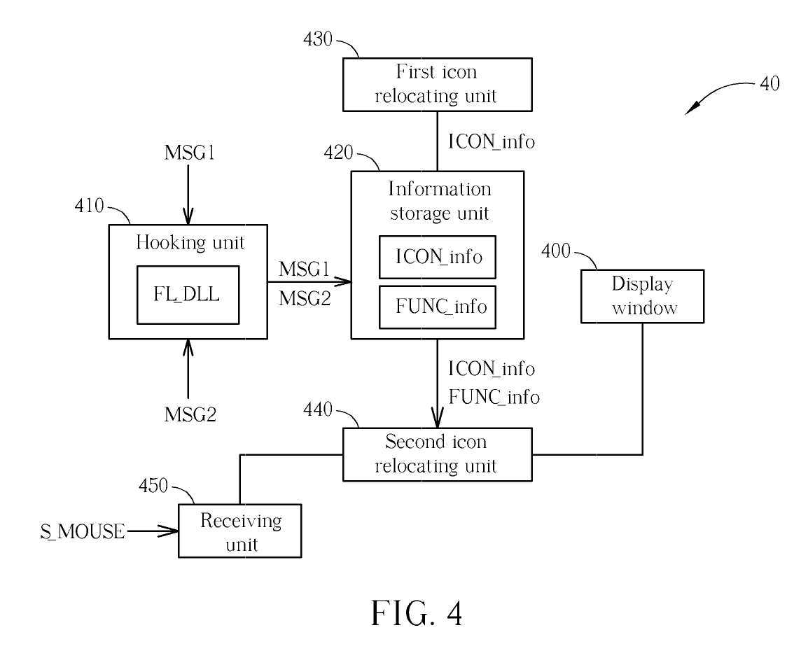

Please refer to FIG. 4, which is a functional block diagram of a computer system 40 according to an embodiment of the present invention. The computer system 40 can be used for realizing the process 20 to relocate a notification icon related to a notification area and includes a display window 400, a hooking unit 410, an information storage unit 420, a first icon relocating unit 430, a second icon relocating unit 440, and a receiving unit 450. The computer system 40 is operated in an operating system (such as the window operating system), and displays a notification area and a display window 400 on a screen. The hooking unit 410 includes a dynamic link library file FL_DLL for hooking a message MSG1 transmitted from the notification area to the operating system, and a message MSG2 transmitted from the operating system to the notification area. The messages MSG1 and MSG2 can be generated according to the application program interface. The information storage unit 420 is used for obtaining icon information ICON_info and function information FUNC_info of the notification icon according to the messages MSG1 and MSG2. The first icon relocating unit 430 is used for hiding the notification icon according to the icon information ICON_info. The second icon relocating unit 440 is used for displaying the notification icon on the display window 400 according to the icon information ICON_info, and providing functions corresponding to the notification icon according to the function information FUNC_info. In order to provide the functions corresponding to the notification icon, the receiving unit 450 is used for receiving a mouse behavior signal S_MOUSE for controlling the second icon relocating unit 440 to display a function menu corresponding to the notification icon or pop up a main window of an application program corresponding to the notification icon.

For the notification icon which has already existed in notification area, the first icon relocating unit 430 deletes the notification icon from the notification area for stopping displaying the notification icon in the notification area. For the new notification icon, the first icon relocating unit 430 directly hides the notification icon to prevent the notification icon from being displayed in the notification area. Since the computer system 40 can be used for realizing the process 20, please refer to the process 20 for the detail.

In conclusion, the embodiments of the present invention relocate and display the notification icon, which attempts to be displayed or is originally displayed in notification area, to a display window independent from the notification area, and maintains original functions related to the notification icon. Therefore, the embodiments of the present invention effectively solve the conventional problem where the notification icon occupies much space and thus influences the taskbar area.

Those skilled in the art will readily observe that numerous modifications and alterations of the device and method may be made while retaining the teachings of the invention.

What is claimed is:

1. A method of relocating and displaying notification icon on a computer system, the method comprising:
hooking messages inputted to or outputted from the notification area;
obtaining icon information and function information of the notification icon according to the hooked messages;
hiding the notification icon;
displaying the notification icon on a display window according to the icon information; and
providing functions of the notification icon according to the function information.

2. The method of claim 1, wherein hooking the messages inputted to and outputted from the notification area comprises utilizing a dynamic link library file to hook messages transmitted between the notification area and an operating system of the computer system.

3. The method of claim 1, wherein providing the functions of the notification icon according to the function information comprises displaying a function menu corresponding to the notification icon, or popping up a main window of an application program corresponding to the notification icon through a mouse behavior.

4. The method of claim 1, wherein the notification icon is a static icon or a dynamic icon.

5. The method of claim 1, wherein hiding the notification icon comprises deleting the notification icon from the notification area for stopping displaying the notification icon in the notification area.

6. The method of claim 1, wherein the messages inputted to and outputted from the notification area are generated according to an application programming interface.

7. A computer system for relocating and displaying notification icon, the computer system comprising:
a hooking unit for hooking messages inputted to or outputted from the notification area;
an information storage unit coupled to the hooking unit, for obtaining icon information and function information of the notification icon according to the hooked messages;
a first icon relocating unit for hiding the notification icon; and
a second icon relocating unit for displaying the notification icon on a display window according to the icon information, and providing functions of the notification icon according to the function information.

8. The computer system of claim 7, wherein the hooking unit utilizes a dynamic link library file to hook messages transmitted between the notification area and an operating system of the computer system.

9. The computer system of claim 7 further comprising a receiving unit coupled to the second icon relocating unit, for receiving a signal of a mouse behavior to control the second icon relocating unit to display a function menu corresponding to the notification icon or pop up a main window of an application program corresponding to the notification icon.

10. The computer system of claim 7, wherein the notification icon is a static icon or a dynamic icon.

11. The computer system of claim 7, wherein the first icon relocating unit further deletes the notification icon from the notification area for stopping displaying the notification icon in the notification area.

12. The computer system of claim 7, wherein the messages inputted to and outputted from the notification area are generated according to an application programming interface.
